(19) United States
(12) Patent Application Publication
(10) Pub. No.: US 2006/0109270 A1
(43) Pub. Date: May 25, 2006

(54) Method and apparatus for providing calligraphic light point display

(75) Inventors: Philippe Marcel Perey, Laval (CA); Andrew E Gruber, Arlington, MA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: CAE INC., St. Laurent, QC (CA)

(21) Appl. No.: 10/533,458

(22) PCT Filed: Nov. 1, 2002
(86) PCT No.: PCT/CA02/01681

§ 371 Date: May 2, 2005

(51) Int. Cl. G06T 15/10; G06T 15/20

(52) U.S. Cl. 345/427

(57) ABSTRACT

A visual display system uses commercial graphics processing units (GPUs) to determine an occlusion of calligraphic light points (CLPs) in a visual display. A color buffer pointer address of the GPUs is changed to point to a CLP subpixel counter and color datum associated with each CLP is changed to an identifier of the respective CLPs so that an occlusion count of GPU indications can be accumulated.

### TECHNICAL FIELD

The present invention relates generally to graphical display systems, and in particular to a system and method for displaying calligraphic light points in a graphical display system.

### BACKGROUND OF THE INVENTION

Complex mobile equipment such as aircraft and military vehicles require tremendous amounts of training time in order for their operators to become proficient. However, the complexity of such systems tends to make them scarce and expensive resources.

As a result, training simulators requiring high-fidelity graphical display systems have been developed. Such simulators provide realistic simulation of the operation of the mobile equipment they are designed to imitate in order to provide training opportunities, while freeing the simulated equipment to be used for the purposes for which they were intended.

By their very nature, high-fidelity display systems are, graphically intensive. The equipment they are intended to model frequently operates at high speeds and with rapidly changing performance characteristics. Furthermore, the environment in which the equipment operates is generally wide-ranging. Still further, in order to be effective, the simulation must be realistic or as nearly so as practical in order to provide a realistic and valuable training experience.

The simulator must therefore be able to identify which features of the simulated environment must be shown at any given time, from the perspective of the person operating the simulator, as if the person were actually operating the equipment in the environment being simulated.

In order to do so, a significant portion of the environmental elements that would be seen by the person if actually operating the equipment, must be graphically rendered, but only if not occluded by another element in the foreground relative to an assumed perspective of the operator.

As a result, the visual systems of such simulators are complex and thus expensive to develop, manufacture and maintain. This is partly due to the nature and extent of the simulation required. For example, in flight simulators, certain minimal performance requirements are imposed in order to be certified for use by the military and commercial aviation authorities.

In the case of simulators for military and commercial aircraft, one of the certification levels is referred to as “Level D Certification”. In order to achieve this certification level, flight simulators must provide effective simulation of operation in low visibility conditions, such as night flight or instrument flying rules (IFR) conditions. One approach to simulation of such conditions is to provide calligraphic light points (CLP). CLPs are points of higher intensity light that overlay the graphical raster image generated by the visual system. CLPs are created by directing the beam of a cathode ray tube (CRT) to dwell on a particular location after the raster image has been generated by the CRT. Typically, the CLPs are created between raster scans, while the beam would otherwise be redirected back to its initial raster scan starting point, also known as the “vertical front porch”. As with the raster image that they overlay, however, CLPs must only be displayed if they are not occluded by an element in the foreground relative to the perspective of the operator.

Heretofore, the generation of raster images and CLPs has been implemented using dedicated and proprietary graphical processing units (GPU) and associated hardware. However, the cost of developing, manufacturing and maintaining those units is becoming prohibitive and is a contributing factor to the cost of building high-fidelity flight simulators. Commercially available GPUs may easily and relatively economically generate raster images at a level that is suitable for high-fidelity simulation systems. However, commercially available GPUs are not adapted to process CLPs in order to determine a CLP occlusion level that translates to a colour/brightness attenuation required for Level D compliance in flight simulators.

Accordingly, there remains a need for a visual system that incorporates commercially available GPUs, but still provides a visual display that meets the requirements for a Level D flight simulator certification.

### SUMMARY OF THE INVENTION

It is therefore an object of the invention to provide a method and apparatus for controlling a display of CLPs using a visual system that incorporates commercially available GPUs.

CLP data and polygon scene element data are stored in a scene element database. A raster image of a displayed environment is first rendered by processing the polygon data using one or more commercially available GPUs that operate in parallel. Processed pixels (or subpixels) that are determined to be in the field of view of a simulator operator located at a fixed point in front of the visual display are written by the GPU to a local color buffer accessed using a color buffer base pointer stored by the GPU.

In accordance with an embodiment of the invention, after the underlying raster image has been generated, the color buffer base pointer provided to the GPU is changed to point to a shared CLP indicator counter rather than to the color buffer. As well, the color portion of the CLP data is replaced with an identifier associated with the CLP, prior to processing by the GPU.

When a GPU processes a modified CLP datum, it determines whether the CLP is occluded, having regard to a Z-buffer populated during generation of the underlying raster image. The GPU indicates, by virtue of the modified color buffer base pointer, to the CLP indication counter, as directed by a mode of operation whether the CLP is occluded. The CLP indicator counter accesses a CLP count register using the identifier stored in the color portion of the datum CLP as an index and increments the value contained therein.

In addition, the unmodified CLP data is provided together with the CLP identifier. The CLP identifier is thereafter used to correlate the unmodified CLP data with the CLP indication counter values, and CLPs that are not occluded are thereafter displayed over the raster image with an intensity commensurate with the accumulated results of the indication reported by each GPU as to whether a particular CLP is occluded.

### BRIEF DESCRIPTION OF THE DRAWINGS

Further features and advantages of the present invention will become apparent from the following detailed description, taken in combination with the appended drawings, in which:

FIG. 1 is a schematic diagram illustrating principal components of a visual display system of a flight simulator shown in an exemplary configuration;

FIG. 2 is a block diagram illustrating principal components of a visual rendering system in accordance with the invention;

FIG. 3 is a flow chart illustrating principal steps in image processing by the visual display system in accordance with the invention; and

FIG. 4 is a timing diagram illustrating principal timing steps in the generation of a display image using the visual display system in accordance with the invention.

It will be noted that throughout the appended drawings, like features are identified by like reference numerals.

### DETAILED DESCRIPTION OF THE PREFERRED EMBODIMENT

The present invention provides a system and method for displaying calligraphic light points in a visual display system using commercially available graphical processing units (GPU).

System Overview

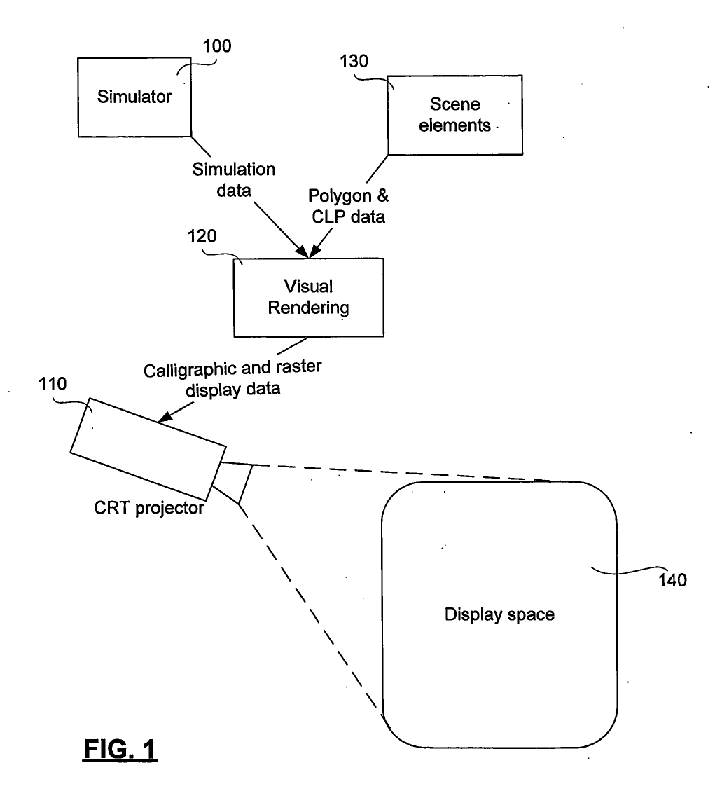

FIG. 1 illustrates an exemplary configuration of a system for displaying graphical simulation data including calligraphic light points using commercially available GPUs; A simulator 100 houses one or more operator(s) in an environment that mimics the environment of operator(s) in equipment of the type being simulated, including an operator's console. The operator(s) interact(s) with the simulator 100 and receive(s) environmental information from the simulator 100 in response thereto. The environmental information may consist of read-outs at the operator's console, aural and motion feedback from the simulator 100 and visual feedback from a display space 140 presented to the operator using a CRT projector 110. The visual rendering 120 prepares a visual display for the operator based on a perspective from a fixed point in front of the display space 140.

The environmental information, including any actions executed by the operator(s) that is relevant to visual rendering is conveyed as simulation data to a visual rendering system 120. Additionally, scene elements defining the surrounding visual environment in which the simulated equipment is operating are stored in a scene element database 130. The surfaces of the scene elements are typically rendered by assembling a plurality of polygons to construct a representation of a desired shape. Conventionally, the polygons are triangles having vertices that are defined by three dimensional coordinates in world space and by a color value, defined in terms of red, green and blue (RGB) intensity values at each vertex. Additionally, a texture, or two dimensional image mapped onto the polygon to enhance the realism is provided for each polygon. Each point in the texture is usually modulated by the RBG values defined at the vertices.

In addition to the polygon data, the scene element database contains calligraphic light point (CLP) data. A CLP is a self-sufficient entity defined by a two-dimensional occlusion mask having its own three dimensional position in world space, colour and other characteristics. In addition, each CLP is identified as either constituting a point source or having a dimension. If the latter, the CLP is said to be a section of generally circular shape and its dimension is also assigned to the CLP. The dimension of the mask, specified in subpixels, must cover exactly the same amount of subpixels (discussed below). Typically, CLPs are arranged in CLP light strings consisting of a series of light points arranged in a straight line having the same characteristics. The polygon and CLP data are provided to the visual rendering system 120.

The visual rendering system 120 processes the simulation data from the simulator 100 and the polygon and CLP data from the scene element database 130 and generates two dimensional display data that it transmits to the CRT projector 110 for display on the display 140 to the operator(s) in the simulator 100.

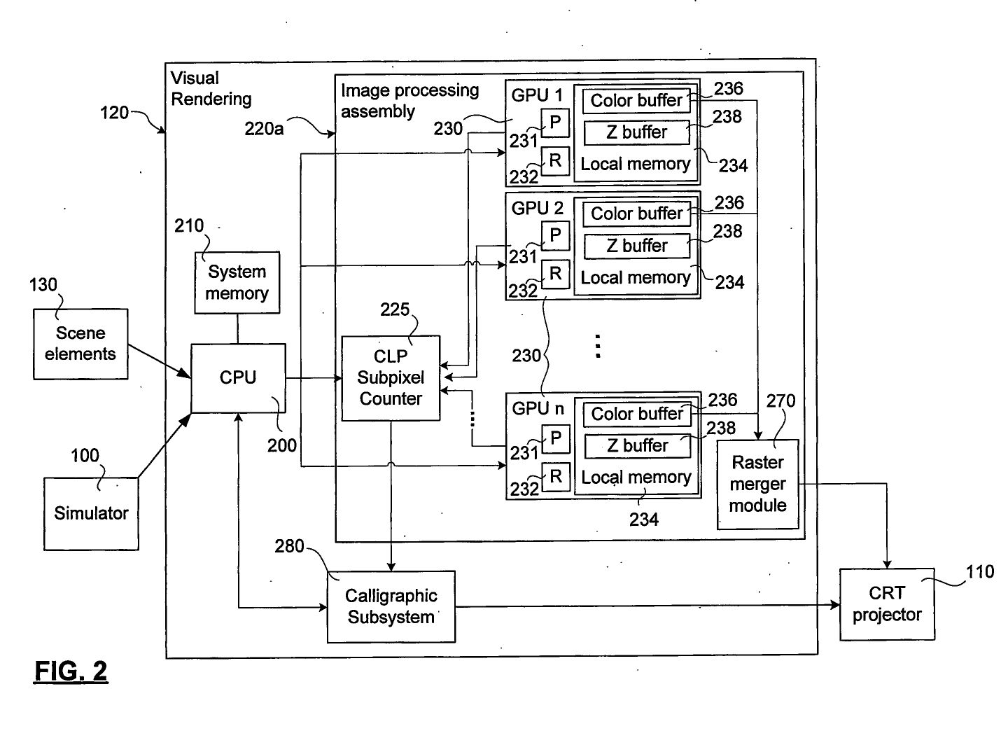

FIG. 2 illustrates an exemplary deployment of the visual rendering system 120. The visual rendering system 120 includes a central processing unit (CPU) 200, system memory 210, at least one image processing assembly 220a and a calligraphic subsystem 280.

A bus, for example a PCI bus, extends between the CPU 200 and the image processing assembly 220. Additionally, a data channel extends from the CPU 200 to the calligraphic subsystem 280. Preferably the data channel permits DMA writes, however, it is sufficient if the CPU writes the data directly along the data channel to the calligraphic subsystem 280.

Generation of the Operator Field of View

The CPU 200 computes, using the simulation data obtained from the simulator 100, what elements, in world view, the operator(s) should see displayed on the display space 140. This information is stored in the system memory 210. The computer 200 accesses such scene elements from the scene elements database and provides them, together with information relating to the position and field of view of the operator, to the image processing assembly 220.

Transmission of CLP Data to the Calligraphic Subsystem

After the CPU 200 has passed the polygon data to the GPU subassemblies 230 for processing, it is free to perform other processing. This time is used to transmit the CLP data corresponding to those scene elements which it has previously determined will be within the operator's field of view to the calligraphic subsystem. As indicated previously, this is preferably accomplished by a DMA transfer. Alternatively, the data may be transferred by direct CPU 200 write operations. In any event, this processing may take place in parallel with the raster rendering processing being performed by the GPU subassemblies 230 and the raster merger module 270 (step 301 discussed below).

The CLP data communicated is the raw CLP data maintained in the scene elements database 130, with the addition of a CLP identifier assigned for the scene. In addition to the CLP identifier, which will be described below, the CLP data consists of the X, Y and Z coordinates in display space corresponding to the CLP, color values expressed, in RGB intensity figures, a dimension expressed in a number of subpixels and sundry other variables, such as the beam focus and dwell time to be used. Technically, the Z coordinate is not used by the calligraphic subsystem 280 and need not be transmitted. The calligraphic subsystem 280 writes this data directly to its own local memory upon receipt.

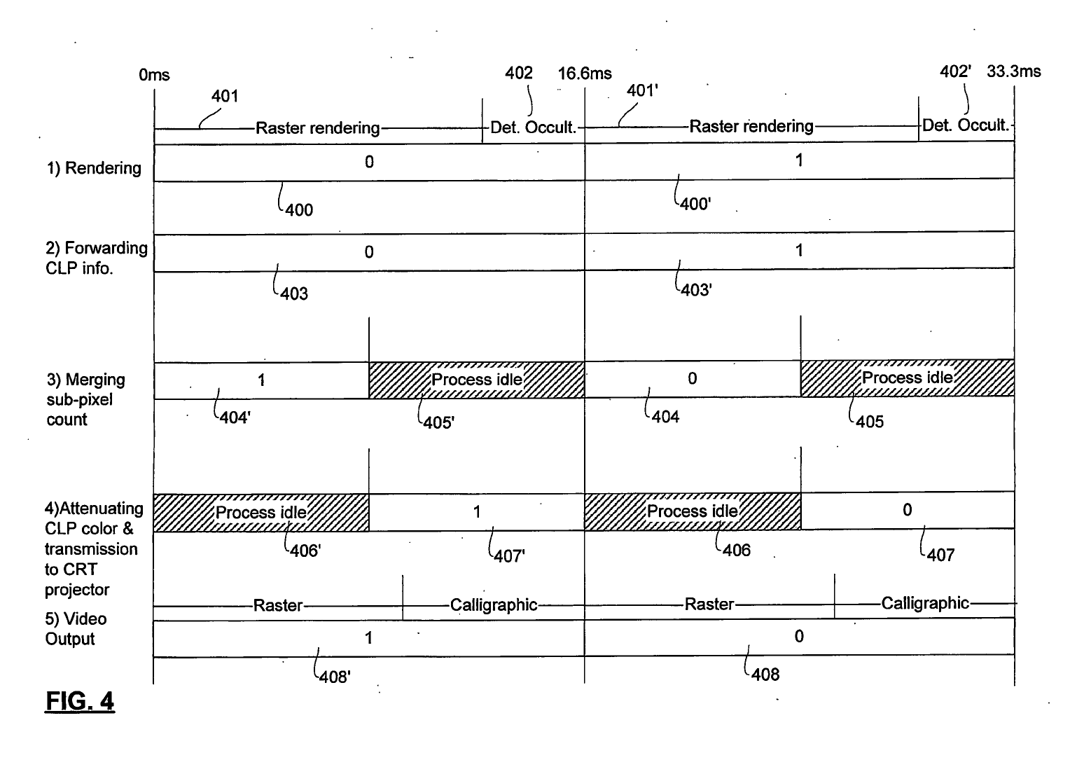

Only a fixed number of CLPs may be processed for any scene. The limitation is driven by the raster refresh period of the. CRT projector 110. This may be seen in FIG. 4, which shows the timing for the generation of the two fields. As indicated, preferably, each scene is drawn in 16.6 ms (shown at 400). For each field, the raster rendering phase (step 301, discussed below), that is, the conversion of polygon data from world space into display space, the determination of what polygon portions are occluded and the drawing of those visible portions, is estimated to require a fraction of the 16.6 ms 401. Therefore, the remaining time from that field and the full 16.6 ms from the opposite field is available in order to perform the calligraphic processing 402, 404, 407. The limiting factor in the number of CLPs that may be displayed is usually the CRT projector 110. It requires a finite amount of time to draw the raster image. CLPs may only be drawn in the remaining time. However, it is important to ensure that the generation of the images to be displayed by the CRT projector 110 does not become the limiting factor.

Raster Rendering (Step 301)

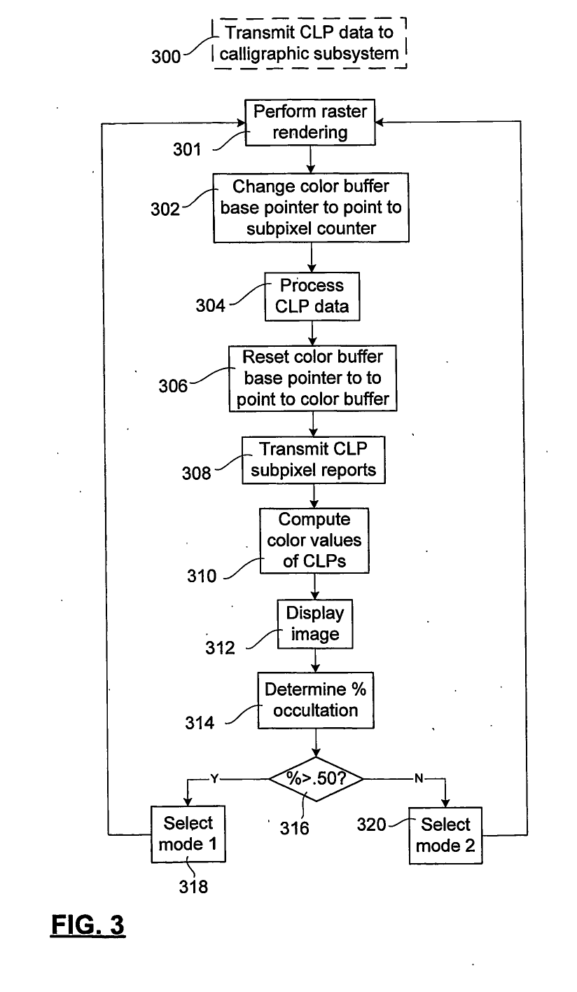

As discussed earlier, the scene elements consist of both polygons and CLPs. FIG. 3 is a flow diagram showing principal steps relating to the processing performed by the image processing assembly 220a. While not performed by the image processing assembly 220, the step, discussed above, of transmitting CLP data to the calligraphic subsystem 280 (step 300) is shown in phantom for context.

In one embodiment of the invention, the first step actually performed by the image processing assembly 220 is to perform the raster rendering (step 301).

In this step, the image processing assembly 220a processes the polygon data to render a raster display image before processing the CLP data. In order to provide a realistic or near realistic image, a scene, or screen display must be shown at least 30 times per second, or every 33.3 ms. Preferably, a scene is displayed 60 times per second, or every 16.6 ms. In order to achieve this, the image processing assembly 220 uses a dual field system, in which a scene is being generated in a first field (field 0) while the second or opposite field (field 1), corresponding to the previous scene is being output to the CRT projector 110.

While only one image processing assembly 220 is shown, for performance reasons related to anti-aliasing or other factors, there are generally a plurality of image processing assemblies 220 that operate in parallel. Consequently four or more can be used. Each of these image processing assemblies 220 operate in similar fashion, with two exceptions. First, one of these image processing assemblies is designated the master image processing assembly 220a and operates in a slightly different way than the others, as will be described below. Second, each image processing assembly 220 is responsible for different sub-pixels, also described below.

Alternatively, the screen may be subdivided into multiple sections, 16 for example. In this case, each image processing assembly 220 may be responsible for a complete portion of the resulting image.

The image processing assembly 220 generally includes a number of GPU subassemblies 230, a CLP subpixel counter 225 and a raster merger processor 270. The PCI bus extending from the CPU 200 is connected to the CLP subpixel counter 225 and to each GPU subassembly 230, permitting them to receive data from the CPU 200. In addition, separate PCI buses permit the CLP subpixel counter 225 to receive data from each GPU subassembly 230. The CLP subpixel counter 225 may be implemented using a field programmable gate array (FPGA) configured with an internal data store. Alternatively, the CLP subpixel counter 225 may constitute a digital signal processor (DSP) type processor, some other type of processor, or an application-specific integrated circuit (ASIC).

The output of the CLP subpixel counter 225 is connected directly to the calligraphic subsystem 280 only on the master image processing assembly 220a. All of the other image processing assemblies 220 are connected in daisy chain sequence, with the output and the input of the CLP subpixel counter 225 of the image processing assembly 220 closest to the master image processing assembly 220a being connected only to the input of the CLP subpixel counter 225 of the master image processing assembly 220a and to the output of the CLP subpixel counter 225 of the next closest image processing assembly 220 and so on.

On the image processing assembly 220, data channels interconnect the GPU subassemblies 230 with inputs on the raster merger module 270. As with the CLP subpixel counters 225, the raster merger modules 270 are connected in daisy chain sequence, with the output and an additional input of the raster merger module 270 of the image processing assembly 220 closest to the master image processing assembly 220a being connected to the additional input of the raster merger module 270 of the master image processing assembly 220a and to the output of the raster merger module 270 of the next closes image processing assembly 220 and so on.

The raster merger modules 270 progressively merge raster data as described below, with the raster merger module 270 of the master image processing assembly 220a outputting the final image over a data channel connected to the CRT projector 110.

When the CPU 200 transmits polygon data over the system bus, identical copies are received by each GPU subassembly 230 of each image processing assembly 220. Each of these applies a different sub-pixel offset to the data. As described above, there are preferably 4 image processing assemblies 220, each containing 4 GPU subassemblies 230 for a total of 16 GPU subassemblies 230. In one embodiment, therefore, each pixel on the display is notionally divided into 16 subpixels, each of which is processed by a particular GPU subassembly 230. Effectively, the display view of the pixel boundary is offset by a fraction of a pixel for each GPU subassembly 230. This offset of the pixel boundary is used by the GPU subassembly 230 to perform anti-aliasing of curves and non-vertical or horizontal lines in the display.

Alternatively, if the GPU subassemblies 23a are assigned a subsection of the display area, as discussed above, offsets may be on the order of 100s of pixels rather than fractions thereof in order to perform the screen subdivision.

But for the subpixel offset assigned to each GPU subassembly 230, processing is identically performed by each GPU subassembly 230. Each GPU subassembly 230 includes a GPU processor 231, local memory 234 and a color buffer base pointer 232. The local memory consists of a color buffer 236 and a Z buffer 238. Normally, the color buffer base pointer 232 points to an initial address of one of the fields (field 0) of the color buffer 236.

As each GPU processor 231 receives polygon data over the bus, it converts the three dimensional world coordinates for the vertices of the polygon into a perspective display space and returns a series of corresponding X, Y and Z coordinates for the polygon. It then compares the Z coordinate returned for each datum with the value in a corresponding location in the Z buffer 238. This location may be obtained by adding offsets corresponding to the X and Y coordinate values for the datum to the initial address in the Z buffer 238, for example. The value in the Z buffer 238 for any point in the X-Y display space denotes the Z value for the object in the display space that has, to that point, been in the foreground, and thus not occluded.

If the Z value for the datum presently being processed by the GPU processor 231 indicates that the datum is, not occluded relative to all previously processed data, the value in the Z buffer 238 for that point in the X-Y display space is updated to the Z value for the datum. Additionally, the color value for the datum is written to a corresponding location in the color buffer 236. This location may be obtained by adding offsets corresponding to the X and Y coordinate values for the datum to an address stored in the color buffer base pointer 232. As indicated, this corresponds to a start address of an appropriate one of two fields in the color buffer memory 236.

Thus, when this process is completed, the color buffer 236 contains color data for only those portions of polygons that are visible (not occluded) to an observer of the rendered scene. The CRT projector 110 therefore does not draw the occluded scene elements. Contents of the color buffer 236, corresponding to the field just processed by each GPU subassembly 230 in each image processing assembly 220 are forwarded to the raster merger modules 270, as described above. Eventually, the raster merger module 270 on the raster image processing assembly 220a determines the color of each pixel based on an evaluation of the N (in this case 16) corresponding subpixels and forwards the resulting display in raster format to the CRT projector 110 for rendering onto the display space 140. This completes the raster rendering phase (step 301).

Alternatively, if the GPU subassemblies 230 are assigned a subsection of the display area, as discussed above, the raster merging process will operate additively, rather than on an averaging basis as described above.

Changing the Color Buffer Base Pointer (Step 302)

At this point, for reasons that will be explained in detail below, the color buffer base pointer 232 is rewritten to point to the CLP subpixel counter 225 (step 302).

Processing CLP Data

Once the polygon data has been processed into a raster format, the GPU subassemblies 230 are now free to perform processing on the CLP data. Accordingly, the CPU 200 forwards CLP data corresponding to those scene elements which it has determined will be within the operator's field of view along the bus to each of the GPU subassemblies 230 in order that the GPU subassemblies 230 may determine if the CLPs are occluded (step 304). The only components of the CLP datum that are transmitted to the GPU subassemblies 230, however, are the three dimensional coordinates in world space and the identifier assigned to the CLP by the CPU 200. The identifier is passed to the GPU subassemblies in the color portion of the datum. The identifier is preferably a sequence number.

The GPU subassemblies 230 process the CLP data in much the same manner as the polygon data that defined the scene elements during the raster rendering phase (step 301). The GPU assemblies 230 are requested to draw a two-dimensional sprite of fixed size equal to the subpixel coverage defined in its dimension, at the three-dimensional coordinate in world space and then to convert the three dimensional world coordinates of the CLP into perspective display space. The Z coordinate is compared with the value in the corresponding location in the Z buffer 238, to determine if the CLP is occluded. However, during this stage the Z buffer is not updated.

Rather, the only processing that is performed by the GPU subassemblies 230 is to update the buffer to which it is directed by the color buffer base pointer by writing the color value associated with the CLP to the local bus. As explained above, the color value associated with each CLP is an identifier (sequence number) that uniquely identifies the CLP in the scene. The writes to the local bus are indications of whether the CLP is occluded, and depend on a mode of operation, as will be explained below. The write addresses are offset by values corresponding to the location of the CLP in X-Y display space. There are, therefore, two fundamental differences between this processing by the GPU subassemblies 230 for polygon data during the raster rendering phase (step 301) and the CLP occlusion phase (step 304).

First, in the raster rendering phase 301, the GPU subassemblies 230 only update the color buffer when the datum is not occluded. The updating process for CLPs depends upon the mode of operation. Under Mode 1, the GPU subassemblies 230 update the buffer when the CLP is not occluded, as in the raster rendering phase. However, in Mode 2, the GPU subassemblies 230 update the buffer when the CLP is occluded, the inverse of the Mode 1 operation. The first and second modes of operation are used to minimize local bus traffic, and therefore save processing time, as will be explained below in more detail.

Second, the buffer which the GPU subassemblies 230 update is no longer the color buffer 236. Since, in step 302, the color buffer base pointer was updated to point to the CLP subpixel counter 225, rather than writing to the color buffer 236, the GPU subassemblies in fact send the color portion of the datum over the local bus to the CLP subpixel counter 225 during this CLP data processing (step 304).

The CLP subpixel counter 225 ignores the offsets corresponding to the point in X-Y display space but rather receives the color portion of the datum, which serves as the CLP identifier. Using the CLP identifier as an index, the CLP subpixel counter 225 increments a count associated with the CLP identifier.

It will be seen that the CLP subpixel counter 225 is updated only when a GPU subassembly 230 sends an indication by writing a color datum to the local bus at an address monitored by the CLP subpixel counter 225. The total count accumulated by the CLP subpixel counters 225 is then used to a color attenuation value that is used by the CRT projector 110 to display the CLP. If the total count maintained by the CLP subpixel counter 225 for a CLP is zero (assuming Mode 1, discussed below), the CLP is completely occluded and is not displayed.

As shown in FIG. 4, the determination of which CLPs are occluded and of the total count for all other CLPs (step 304) must be performed in the fraction of time (shown at 402) remaining for processing the field, after completion of the raster rendering phase (step 301).

Resetting the Color Buffer Base Pointer (Step 306)

After the determination of which CLPs are occluded is completed (step 304), the color buffer base pointer 232 is reset once again, this time to point back to the initial address of the local color buffer 236 (step 308). However, the opposite field (ie field 1 if field 0 was previously rendered) is accessed, so that the next scene uses the opposite field. This redirection must take place within 16.6 ms (as shown at 400′) after commencement of the initial raster rendering phase (step 301), in order to permit the commencement of raster rendering for the opposite field (field 0) at the proper time.

Transmit CLP Subpixel Reports (Step 308)

The next step in the processing by the image processing assemblies 230 is to transmit the CLP subpixel reports (accumulated counts) to the calligraphic subsystem 280 (step 308). This is performed by the various CLP subpixel counters 225 on the respective image processing assemblies 220. Starting with the image processing assembly 220n farthest away from the master image processing assembly 220a, the CLP subpixel counter 225 sends its subpixel counts to the CLP subpixel counter 225m of the next image processing assembly 220m. That CLP subpixel counter 225m adds the results received from CLP subpixel counter 225n to the results received from its own GPUs 231 and sends the total as its subpixel count to the CLP subpixel counter 225l of the next image processing assembly 2201, and so on, until the CLP subpixel counter 225a on the master image processing assembly 220a sends the total subpixel count to the calligraphic subsystem 280, in sequence order determined by the CLP identifier.

The calligraphic subsystem 280 receives these counts and correlates them with the corresponding CLP data it received from the CPU 200 the CLP identifier. In so doing, it determines an appropriate color attenuation factor to be applied to each CLP, according to one of the following equations:

$$\begin{matrix}\begin{matrix}Mode 1 \text{:} & Color Attenuation Factor = \frac{Count}{Maximum Count}\end{matrix} & ( 1 ) \\ \begin{matrix}Mode 2 \text{:} & Color Attenuation Factor = \frac{Maximum Count - Count}{Maximum Count}\end{matrix} & ( 2 )\end{matrix}$$

where Count is the total number of counts for the CLP returned by the CLP subpixel counter 225 on the master image processing assembly 220a to the calligraphic subsystem 280, and Maximum Count is the size of the occlusion mask and corresponds to the maximum possible subpixel count for the CLP.

The two equations are applied in accordance with the mode of operation. In Mode 1, indicators are returned by the GPUs if the CLP is not occluded. In Mode 2, as described above, indicators are returned by the GPUs if the CLP is occluded. Accordingly, in Mode 2, the count must be subtracted from the total number of GPUs for consistency.

The determination of the applicable color attenuation factor for each CLP must be completed a reasonable time, for example, 2 ms, before the start of the calligraphic output phase.

During this time, the process of outputting the raster data from the first field (field 0) to the CRT projector 110 will commence and require approximately 10 ms to complete 408.

Determine Color Values of CLPs (Step 310)

The color attenuation factor determined by appropriate application of Equation 1 or 2 will be applied to attenuate the color intensity value for each of the red, green and blue color values associated with the CLP 407. The attenuated color is then used to index a gamma look-up table. The final CLP information with its gamma corrected color is sent to the projector 110, whereupon it is stored in a FIFO until it is time to display it.

This process will commence before the start of the calligraphic output phase.

Display Image (Step 312)

Once the process of outputting the raster data to the CRT projector 110 has completed, the output of the calligraphic data will commence. The CRT projector 110 starts reading its FIFOS, which have already begun to be filled and will continue to be filled with CLP data until there are no more. The CRT projector 110 will draw the CLPs in sequence as they are read from the FIFOs. As discussed above in respect of step 310, the FIFOs begin to fill with CLPs a reasonable time before this calligraphic output phase (step 312) begins, to ensure that no time is wasted when the calligraphic output begins.

Determine Percentage Calligraphic Occlusion Steps 314-320)

After the completion of step 308, the calligraphic subsystem 280 knows the total counts recorded for each CLP displayed in the field (field 0). In addition to determining the color attenuation factors for each CLP, the calligraphic subsystem 280 determines the total subpixel count for CLPs in that field (field 0). It uses this information for the purpose of determining the mode of operation for the opposite field (field 1).

Algorithms of varying complexity may be used for this purpose. For exemplary purposes, a simple algorithm might consist of counting the total number of occluded CLPs and computing a percentage of occlusion (step 314). If more than 50% of the total number of CLPs in a current field are occluded (step 316), then Mode 1 is selected for the next field (step 318). On the other hand, if the percentage of occluded CLPs is less than 50% of the total number of CLPs in the current field, then Mode 2 is selected (step 320) for the next field.

The reason for two operating modes is to reduce the number of indications written to the local CLP subpixel counter 225 by the GPUs 230 and thus processing time.

General Comments

The present invention can be implemented in digital electronic circuitry, or in computer hardware, firmware, software, or in any combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD disks. Any of the foregoing can be supplemented by, or incorporated in ASICs (application-specific integrated circuits).

Examples of such types of computers are programmable processing systems contained in the CPU 200, CLP subpixel counter 225, GPUs 231 and calligraphic subsystem 280 shown in FIG. 2 suitable for implementing or performing the apparatus or methods of the invention. The system may comprise a processor, a random access memory, a hard drive controller and an input/output controller coupled by a processor bus.

It will be apparent to those skilled in this art that various modifications and variations may be made to the embodiments disclosed herein, consistent with the present invention, without departing from the spirit and scope of the present invention. For example, the approach described herein need not be constrained to a subpixel distribution of the image across GPUs. Alternatively, it may be applied in the situation where the screen is subdivided into multiple (say 16) sections. In this case, each GPU sub-assembly 230 accumulates a number of occlusion counters for CLPs in its assigned area, and the end accumulation will accumulate the results of CLPS at the border of each GPU's assigned screen portion.

Moreover, the criteria for occlusion need not be constrained to a comparison with the Z buffer 238. Rather, it may include information from a stencil buffer to determine the occlusion level. This may be particularly the case when the Z buffer 238 does not have the required resolution to properly determine an occlusion status with a CLP that is almost co-planar to a raster polygon at a large distance.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the appended claims.

1. A visual display system for displaying calligraphic light points (CLPs) on a two-dimensional display, comprising:
a processor for replacing a color portion of data characterizing the respective CLPs with digital information;
a graphical processing unit (GPU) for mapping three-dimensional coordinates of the CLPs into a two-dimensional display space, determining whether the respective CLPs are visible with respect to a fixed point in front of the two-dimensional display, and returning an indication of same;
an occlusion counter for receiving the indications and incrementing a data store used to control a display of the CLPs in accordance with the digital information; and
means for computing display characteristics of the respective CLPs in accordance with the contents of the data store.

2. A visual display system as claimed in claim 1 wherein the GPU comprises a commercially available unit adapted to perform three-dimensional raster image processing.

3. A visual display system as claimed in claim 2 wherein the processor is adapted to change a content of a color buffer base pointer address register of the GPU.

4. A visual display system as claimed in claim 1 wherein the GPU is adapted to operate in a first mode in which they return the indication when a CLP is visible with respect to the fixed point and a second mode in which it returns the indication when a CLP is not visible with respect to the fixed point.

5. A visual display system as claimed in claim 1 wherein the processor is adapted to compute a percentage of the CLPs that were visible in a previous frame displayed by the visual system and further adapted to select a mode of operation for the GPU based on the percentage computed.

6. A visual display system as claimed in claim 1 wherein the occlusion counter comprises a field programmable gate array.

7. A visual display system as claimed in claim 1 wherein the occlusion counter comprises a digital signal processor.

8. A visual display system as claimed in claim 1 wherein the subpixel counter comprises an application-specific integrated circuit.

9. A visual display system as claimed in claim 1 wherein the means for computing comprises a calligraphic subsystem comprising means for computing a color attenuation of each CLP that is visible with respect to the fixed point.

10. A method of displaying a calligraphic light points (CLPS) on a two-dimensional display, comprising steps of:
replacing a color portion of data characterizing the respective CLPs with digital information;
mapping three-dimensional coordinates of the respective CLPs into a two-dimensional space;
determining whether the respective CLPs are visible with respect to a fixed point in front of the two-dimensional display and returning an indication of same;
incrementing a data store used to control a display of the respective CLPs as the respective indications are returned, in accordance with the digital information; and
computing display characteristics of the respective CLPs in accordance with the contents of the data store.

11. A method as claimed in claim 10 wherein the step of incrementing comprises using the digital information as an index into the data store and incrementing a portion of the data store indexed thereby.

12. A method as claimed in claim 10 wherein the step of displaying comprises displaying the CLP over an underlying two dimensional graphical display to provide increased intensity to the display at the coordinates corresponding to the CLP.

13. A graphical processing unit (GPU) adapted to accept a series of three-dimensional data points each containing a color value and map them to a two-dimensional display space,
wherein the color values of the data points provided to the GPU may be replaced by digital information,
whereby the mapped two-dimensional data points may be stored according to the digital information provided in the data point.

14. A data point comprising a coordinate portion and a color portion for processing by a graphical processing unit,
wherein the color portion stores digital information so that the processed data point may be stored in a data store according to the digital information provided in the color portion.

15. A data point as claimed in claim 14, wherein the information identifies the data point.
